(19) United States
(12) Patent Application Publication
(10) Pub. No.: US 2009/0064424 A1
(43) Pub. Date: Mar. 12, 2009

(54) GROUND FABRIC FOR MASKING FOR USE IN METHOD OF TRANSFER PIECE DYEING OF EMBROIDERED PART

(75) Inventors: Junya Ide, Ehime (JP); Suguru Mizuki, Ibaraki (JP); Keisuke Takishima, Hyougo (JP); Hideki Kamada, Okayama (JP); Junichi Sugino, Osaka (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kuraray Co. Ltd., Kurashiki-shi (JP)

(21) Appl. No.: 11/913,198

(22) PCT Filed: Jun. 1, 2006
(86) PCT No.: PCT/JP2006/310967

§ 371 Date: Apr. 25, 2008

(30) Foreign Application Priority Data
Jun. 3, 2005 (JP) 2005-163619

(51) Int. Cl. D06P 5/00; B32B 9/00; B32B 27/30

(52) U.S. Cl. 8/478; 428/411.1; 428/500; 428/340

(57) ABSTRACT

A masking sheet which is composed of a laminated composite sheet of a water-soluble film and a support made of water-soluble fibers. The masking sheet is used to prevent the migration of dye during a transfer dyeing through embroidery stitches in the production of embroidered fabrics which includes a step of piece-dyeing embroidered patterns using a transfer paper. The masking sheet is easily removed by dissolution in water. Therefore, the masking sheet is suitable for producing embroidered fabrics with good touch which have embroidery patterns with dear color and distinct profile even when the colored patterns are intricate.

### TECHNICAL FIELD

The present invention relates to masking sheets capable of effectively preventing the migration of dyes into non-embroidered areas during the coloring or dyeing of embroidered patterns using transfer papers, and further relates to embroidered fabrics produced by using such masking sheets.

### BACKGROUND ART

To form colored embroidered patterns, a variety of yarn-dyed, single-colored or multi-colored embroidery threads has been conventionally used. The number of colors of colored embroidered patterns is limited by the number of the embroidery threads with different colors to be used. Particularly, in the industrial embroidery process, the number of usable colors of embroidery threads is limited by embroidery machines, production costs, and risk in storing expensive yarn-dyed embroidery threads of various kinds. Therefore, it is quite difficult in the industrial process to embroider variously colored patterns on fabrics.

To embroidery variously colored patterns, there has been proposed a piece-dyeing method in which the embroidery patterns are colored or dyed using transfer papers. In this method, transfer papers carrying sublimable dyes have been widely used because the sublimable dyes are clear and good in color fastness to washing. However, since the transfer paper is coated with dye usually throughout its entire surface, colored patterns are also transferred to the non-embroidered area on the fabric, thereby making the profile of embroidered patterns vague to spoil the appearance of embroidered patterns. Also proposed is a method in which the non-embroidered areas are masked by a masking material in advance to the coloring or dyeing using a transfer paper. However, it is difficult to completely mask the patterns such as voided characters and complex loose embroidered patterns, and the removal of the masking material after the heat transfer is also difficult.

To prevent the non-embroidered area from being colored or dyed, proposed is a method in which the embroidered pattern is formed on an embroidery base fabric covered with a masking material, and the masking material is peeled away together with a transfer paper after the color transfer (for example, Patent Document 1). The masking material proposed in Patent Document 1 is composed of a paper support made of woodfree paper or simili paper, which has a release agent layer on its side to become contacted with the embroidery base fabric and a hot-melt adhesive layer on its side to be transferred. Since the release agent, the paper support and the hot-melt adhesive remain under the embroidered patterns after removing the masking material, the proposed method involves problems of poor touch and poor soft feel of embroidered patterns. In addition, the embroidery threads are broken during the removal of the masking material to damage the embroidered patterns, and the masking material cannot be completely removed.

To improve the touch of embroidered patterns after the removal of the masking material, it is proposed to use a masking material which is made of a water-soluble film or a water-degradable thin simili paper or toilet paper in place of the paper support made of woodfree paper or simili paper (for example, Patent Document 2). When the water-soluble film is used, the masking material underlying embroidered patterns can be easily removed together with a release agent and a hot-melt adhesive by the washing of embroidery base fabric, without deteriorating the touch and soft feel of the embroidered patterns. However, since the water-soluble film per se is poor in mechanical strength, the embroidery stitches are easily broadened. In a sublimation transfer using a disperse dye, therefore, the vaporized dye penetrates through the broadened stitches to migrate into the vicinity of the embroidered pattern profile. In the heat transfer using a press machine, the water-soluble film is broken because of its poor strength. The pieces broken off adhere to the heat source to deteriorate the workability. In case of using the water-degradable thin simili paper or toilet paper, the release agent and the hot-melt adhesive are hardened to likely cause uneven touch, and the paper is defibrated into fibers by washing to allow the fibers to come out of the broadened stitches.

In another proposed method, the masking material is removed from the embroidery area in advance before forming embroidered patterns thereon (or example, Patent Document 3). This method includes sequential steps of embroidering a border around the embroidery area on a superposed embroidery base fabric and masking material; removing the masking material from the embroidery area; forming embroidered patterns on the embroidery area; dyeing the embroidered patterns using a transfer paper; and removing the masking material from the non-embroidered area. However, the proposed method is restricted by embroidery machines and production costs, because it requires additional steps of embroidering the border and removing the masking material in advance to the embroidery work. In addition, it is extremely difficult, if the embroidery pattern is intricate, to remove only the masking material selectively from the embroidery area prior to the embroidery work.

[Patent Document 1] JP 7-133596A

[Patent Document 2] JP 9-123695A

[Patent Document 3] JP 2000-64183A

### DISCLOSURE OF INVENTION

An object of the present invention is to provide a masking sheet for use in the production of embroidered fabrics including the coloring or dyeing process of embroidered patterns by piece-dyeing using a transfer paper, which is excellent in preventing the migration of dye. Another object is to provide a masking sheet which is easily removed by dissolution in water after the coloring or dyeing using a transfer paper. Still another object is to provide embroidered fabrics which have embroidered patterns with clear color, clear profile and good touch even when the embroidered patterns are intricate colored patterns.

As a result of extensive research in view of obtaining the masking sheets and the embroidered fabrics, the inventors have found that embroidered fabrics with good touch and soft feel without migration of dye into the vicinity of embroidered patterns are produced by: covering at least a part of the surface of embroidery base fabric to be embroidered (hereinafter may be referred to as “embroidery surface”) with a composite sheet (masking sheet) prepared by laminating a support (paper or nonwoven fabric) constituted by water-soluble fibers and a water-soluble film; producing embroidered patterns on the superposed masking sheet and embroidery base fabric; dyeing the embroidered patterns by a heat transfer using a transfer paper; and then, immersing the masking sheet in water to easily and completely remove the masking sheet by dissolution.

Namely, the present invention relates to a water-soluble masking sheet for use in a piece-dyeing of embroidered patterns using a transfer paper, which is made of a laminated composite sheet of a water-soluble film and a support made of water-soluble fibers. The water-soluble masking sheet is used for preventing the migration of dye into the non-embroidered area by covering at least a part of the surface to be embroidered of a embroidery base fabric.

The present invention further relates to an embroidered fabric which is produced by: forming embroidered patterns on superposed masking sheet and embroidery base fabric; dyeing the embroidered patterns by a heat transfer or a pressure transfer; and then, removing the masking sheet by dissolving in water.

### BEST MODE FOR CARRYING OUT THE INVENTION

The present invention will be explained below in detail.

In the production of the embroidered fabrics utilizing the masking sheet, the embroidered patterns are dyed by a piece-dyeing method using a transfer paper. First, an embroidery base fabric is covered with a masking sheet on its embroidery surface which includes at least the area to be embroidered (embroider area). The masking sheet is composed of a laminated composite sheet of a water-soluble film and a support made of water-soluble fibers, and is overlaid on the embroidery surface via its support. After forming embroidered pattern on the superposed masking sheet and embroidery base fabric, the colored pattern formed on the transfer paper is heat-transferred or press-transferred onto the embroidered pattern. Thereafter, the transfer paper is peeled off and the masking sheet is removed by dissolution in water. Even when the masking sheet is colored or dyed during the transfer dyeing, the masking sheet underlying the embroidered pattern is also completely removed to give an embroidered fabric having only the embroidered pattern attractively colored.

The embroidery base fabric and the embroidery threads are made of natural fibers such as cotton, silk and wool, or synthetic fibers such as polyester fibers and polyamide fibers, although not limited thereto.

When a cut-out transfer paper matching the shape of embroidered pattern is used, a masking sheet having a dimension enough to cover the embroidered pattern and its periphery can be used. However, it is generally preferred that the masking sheet has a dimension sufficient for covering the entire surface of the embroidery base fabric in view of workability, etc.

The transfer paper is generally a sublimation transfer paper which can heat-transfer a colored pattern formed by using a highly migratory disperse dye onto the embroidered pattern, although not limited thereto. If necessary, a press transfer paper having a colored pattern made of a pigment or dye is also usable.

The masking sheet of the invention is characterized in that it is made of a laminated composite sheet of a water-soluble film and a water-soluble support. By the use of such a masking sheet, the migration of dye during the transfer operation to the vicinity of embroidered patterns through the embroider stitches is prevented. In addition, the masking sheet does not adhere to the heat source during the heat transfer, to enhance the workability. Since the masking sheet is made of the water-soluble fiber and the water-soluble film, the masking sheet not only in the non-embroidered area but also underlying the embroidered pattern is substantially completely removed by the dissolution in water. Therefore, the transfer pattern is clearly transferred onto the embroidered pattern even when the transfer pattern is intricate and multi-colored, and embroidered fabrics having the embroidered patterns with good touch are obtained.

The water-soluble fiber and the water-soluble film are preferably made of a polyvinyl alcohol resin (PVA resin), because the tenacity of fiber is high and the dissolving temperature in water can be regulated. The temperature of water at which the PVA masking sheet is soluble (dissolving temperature in water) is preferably from 0 to 100° C., and particularly preferably from 0 to 70° C. because the disperse dye for the sublimation transfer paper partly dissolves in water at 80° C. or higher to likely cause migration.

PVA resin having a dissolving temperature in water of from 0 to 70° C. is preferably a partially saponified PVA including only vinyl acetate unit in addition to vinyl alcohol unit and having a saponification degree of 98 mol % or less. If the saponification degree is less than 80 mol %, the resultant water-soluble fiber is low in crystallizability and fibers adhere to each other during their production.

PVA resin having a dissolving temperature in water of from 70 to 100° C. is preferably a partially saponified PVA having a saponification degree of from 98 to 99.5 mol %. A completely saponified PVA having a saponification degree of 99.5 mol % or more is also made into a masking sheet which is soluble in boiling water, if it has been dry-heat drawn at 200° C. or lower.

A modified PVA is also usable as far as its dissolving temperature in water is from 0 to 100° C. When a masking sheet having a dissolving temperature in water of 0 to 70° C. is intended, the content of modifying units is preferably from 1 to 20 mol % and more preferably from 2 to 13 mol %. When a masking sheet having a dissolving temperature in water of 70 to 100° C. is intended, the content of modifying units is preferably from 0.1 to 1 mol %. Examples of the modifying units include those derived from ethylene, allyl alcohol, itaconic acid, acrylic acid, vinylamine, maleic anhydride, maleic acid, sulfonic acid-containing vinyl compounds, vinyl ester of fatty acids having 4 or more carbon atoms such as vinyl pivalate, and vinylpyrrolidone. Also usable are units derived from compounds prepared by partly or entirely neutralizing the ionic groups of the above compounds. The modifying unit is introduced by either copolymerization or post-reaction. The modifying units may be arranged randomly or in block in the polymer backbone, or may be grafted to the polymer backbone.

The degree of polymerization of PVA resin is not critical, and preferably 1000 or more and more preferably 1500 or more in view of the mechanical properties and water absorptivity of fibers, and preferably 4000 or less in view of the spinning properties.

The water-soluble masking sheet of the invention is particularly suitable when the colored pattern on the transfer paper is formed by a sublimable dye such as a disperse dye. The sublimable dye is useful for forming an intricate multi-colored pattern with gradations. Generally, the sublimable dye migrates into the non-embroidered area through the embroidery stitches during the dyeing using a transfer paper, or dissolves in water during the removal of a masking sheet by a hot water of 80° C. or higher to stain the non-embroidered area of the embroidered fabrics. In the present invention, however, such a migration of dye during the dyeing and the removal of masking sheet is effectively prevented, because the dissolving temperature in water of the water-soluble masking sheet can be suitably regulated by selecting the PVA resin for forming the masking sheet, and the sublimable dye can be retained on the masking sheet by making it from a laminate of the water-soluble PVA support and the water-soluble PVA film. Therefore, the present invention enables the production of embroidered fabrics having embroidered patterns with a good touch which are dyed into intricate multi-colored pattern with gradations.

The method of producing the water-soluble PVA fiber used in the invention will be described below. By spinning a spinning solution prepared by dissolving the water-soluble PVA resin in water or an organic solvent in the manner to be described below, fibers excellent in mechanical properties can be efficiently produced. The spinning solution may contain an additive and another polymer in amounts not adversely affecting the effects of the invention. Examples of the solvents for the spinning solution include water; polar solvents such as dimethylsulfoxide (DMSO), dimethylacetamide, dimethylformamide and N-methylpyrrolidone; polyhydric alcohols such as glycerol and ethylene glycol; mixtures of the preceding solvent and a swelling metal salt such as rhodanate, lithium chloride, calcium chloride and zinc chloride; mixtures of the preceding solvents; and mixtures of water and the preceding solvent, with water, DMSO and a mixture thereof being particularly preferred because of their high solvent power at low temperatures, low toxicity and low corrosiveness.

The concentration of the PVA resin in the spinning solution is preferably from 8 to 40% by mass, although depending on the composition, degree of polymerization and solvent. The extrusion temperature of the spinning solution is regulated so as to prevent it from being gelated, decomposed or discolored, and is preferably in a range of from 50 to 150° C. The spinning solution is extruded from a nozzle and made into fibers by a wet spinning method or a dry-wet spinning method. The extruded spinning solution is coagulated in a coagulation bath for PVA resin. The wet spinning method is preferably used rather than the dry-wet spinning method when a multi-holed spinneret is used, because the sticking between extruded fibers is prevented. In the wet spinning method, the spinning solution is extruded from the spinneret directly into the coagulation bath, while extruded first into air or inert gas atmosphere and then introduced into the coagulation bath in the dry-wet spinning method.

In the present invention, different coagulation baths are used according to the solvent of spinning solution, i.e., different coagulation baths are used between organic solvent and water. When the solvent of spinning solution is an organic solvent, a coagulation bath composed of a mixture of the coagulation solvent and the solvent of spinning solution is preferably used in view of tenacity of resultant fibers. The coagulation solvent may be an organic solvent having an ability of coagulating PVA resin, for example, alcohols such as methanol and ethanol, and ketones such acetone and methyl ethyl ketone. Particularly preferred is a coagulation bath composed of a methanol/DMSO mixture. The ratio, coagulation solvent/solvent of spinning solution, in the coagulation bath is preferably from 25/75 to 95/5 by mass, and more preferably from 55/45 to 80/20 in view of process efficiency and recovery of solvents. The temperature of coagulation bath is preferably 30° C. or lower, and in view of ensuring uniform gelation by cooling, the temperature is more preferably 20° C. or lower and still more preferably 15° C. or lower. When the solvent of spinning solution is water, the coagulation solvent is preferably an aqueous solution of inorganic salts having an ability of coagulating PVA resin such as sodium sulfate, sodium chloride and sodium carbonate. The coagulation bath may be acidic, neutral or alkaline.

Then, the solvent of spinning solution is removed from the coagulated fibrous product by extraction. To prevent the sticking between fibers in the drying step and enhance the tenacity of the resultant fibers, the fibrous product is preferably wet-drawn during the extraction. The wet draw ratio is preferably from 2 to 6 times. The extraction is generally performed by passing the fibrous product through two or more extraction baths. The extraction bath is preferably composed of the coagulation solvent alone or a mixture of the coagulation solvent and the solvent of spinning solution. The temperature of the extraction bath is preferably from 0 to 50° C.

Then, the fibrous product was dried to obtain the water-soluble fiber. The drying may be performed after providing an oil agent. The drying is conducted preferably at 210° C. or lower, and more preferably conducted by two stages: 160° C. or lower at the initial stage and elevated temperature at the later stage. It is preferred to dry heat-drawing, and dry-heat shrinking if necessary, the fiber to orient the polymer chains and enhance the tenacity of fibers. If the tenacity of fibers is too low, the process efficiency is expected to be reduced, for example, in the production of the support such as nonwoven fabric. To enhance the mechanical properties of the water-soluble fiber, it is preferred to dry heat-drawing the fibers at 120 to 250° C. in a draw ratio of 1.1 to 8.0 times to make the tenacity within the range of from 2.0 to 15.0 cN/dtex.

The fineness of the water-soluble fiber is preferably from 0.1 to 1000 dtex and more preferably from 1 to 400 dtex, although not limited thereto. The fineness can be regulated by suitably selecting the nozzle diameter or draw ratio.

The support such as paper or nonwoven fabric is produced from the water-soluble fiber by any method without limitation, for example, by a dry or wet method conventionally employed in the production of paper or nonwoven fabric. In a dry method of producing nonwoven fabric, two or more card or air-lay webs of water-soluble fibers are laminated by embossing or calendering using a heating roll to produce intended nonwoven fabric efficiently. The web may be made from mixed water-soluble fibers of different types. Two or more webs each made of different types of water-soluble fibers may be laminated by embossing or calendering. To obtain a uniform nonwoven fabric with little irregular formation, the arrangement of fibers may be made random by a crosslap method or a christ cross method. Alternatively, the water-soluble fiber is efficiently made into intended paper by a common wet paper machine using water at a lower temperature than the dissolving temperature in water of the water-soluble fiber. The wire cloth to be used may include a cylinder wire, a short wire and endless wire. The wire cloth may be used alone to make single-layered paper, or used in combination to make multi-layered paper. A slurry of the paper stock such as the water-soluble fiber and a binder fiber is made into green paper which is then dried by Yankee dryer, to obtain intended paper. The dried paper may be heat-pressed, if necessary.

The production method of the water-soluble PVA film will be described below. The film-forming solution for the water-soluble PVA film is prepared by mixing the PVA resin with a plasticizer, a surfactant and an optional inorganic filler in an appropriate method.

The water-soluble film is generally transported, stored or used in a steamy district or a cold district. Therefore, the strength and toughness are required for the water-soluble film, and particularly, the impact resistance at low temperatures is important. To enhance the impact resistance, the glass transition point of film is reduced by blending various types of plasticizers. The plasticizer is selected from any types of plasticizers which are generally used for PVA, for example, polyhydric alcohols such as glycerol, diglycerol, diethylene glycol, trimethylolpropane, triethylene glycol, dipropylene glycol and propylene glycol; polyethers such as polyethylene glycol and polypropylene glycol; phenol derivatives such as bisphenol A and bisphenol S; amide compounds such as N-methylpyrrolidone; and adducts of ethylene oxide and a polyhydric alcohol such as glycerol, pentaerythritol and sorbitol. These plasticizer may be used alone or in combination of two or more.

The blending amount of the plasticizer is preferably from 5 to 30 parts by mass, more preferably from 8 to 25 parts by mass, and still more preferably from 10 to 20 parts by mass per 100 parts by mass of the PVA resin. If less than 5 parts by mass, the impact resistance will be insufficient. If exceeding 30 parts by mass, the bleed out of the plasticizer becomes significant to make the films easy-to-blocking. In addition, the resultant film has a moderate stiffness and passes through a bag-forming machine, etc. without difficulties when the blending amount is 30 parts by mass or less. In view of increasing the water solubility of the resultant film, the blending amount is preferred to be as much as possible within the above range.

The surfactant is preferably anionic or nonionic, but not limited. Preferred anionic surfactants include a carboxylic acid type such as potassium laurate, a sulfate type such as octyl sulfate, and a sulfonic acid type such as dodecyl benzenesulfonate. Preferred nonionic surfactants include an alkyl ether type such as polyoxyethylene lauryl ether and polyoxyethylene oleyl ether; an alkylphenyl ether type such as polyoxyethylene octylphenyl ether; an alkyl ester type such as polyoxyethylene laurate; an alkylamine type such as polyoxyethylene laurylamino ether; an alkylamide type such as polyoxyethylene laurylamide; a polypropylene glycol ether type such as polyoxyethylene polyoxypropylene ether; an alkanolamide type such as oleic acid diethanolamide; and an allylphenyl ether type such as polyoxyalkylene allylphenyl ether. These surfactants may be used alone or in combination of two or more. In view of preventing the blocking, preferred are the alkyl ether surfactants, with polyoxyethylene oleyl ether being particularly preferred.

The addition amount of the surfactant is preferably from 0.01 to 2 parts by mass, more preferably from 0.1 to 1 part by mass, and still more preferably from 0.2 to 0.5 part by mass each base on 100 parts by mass of the PVA resin. If less than 0.01 part by mass, the formed film or the film-forming solution which is adhered to the die or drum of the film-forming machine is difficult to be removed from the metal surface, thereby making the forming of the water-soluble film difficult. If exceeding 2 parts by mass, the surfactant emerges into the film surface to cause blocking of the films and reduce the handling ability of the films.

Examples of the inorganic fillers include silica, ground, precipitate or surface-treated calcium carbonate, aluminum hydroxide, aluminum oxide, titanium oxide, diatomaceous earth, barium sulfate, calcium sulfate, zeolite, zinc oxide, silicc acid, silicate, mica, magnesium carbonate, day such as kaolin, halloysite, pyrophyllite and sericite, and talc, with silica and talc being preferred because of their good dispersibility in the PVA resin. These inorganic fillers may be used alone or in combination of two or more. The particle size of the inorganic filler is preferably 1 μm or more in view of preventing the blocking, and preferably 10 μm or less in view of the dispersibility in the PVA resin. To achieve these advantages simultaneously, the particle size is more preferably from about 1 to about 7 μm. The blending amount thereof, if used, is preferably from 0.001 to 10 parts by mass, more preferably from 0.005 to 3.0 parts by mass, and still more preferably from 0.01 to 1.0 part by mass each based on 100 parts by mass of the PVA resin.

The water-soluble PVA film may be included, if necessary, a common additive such as colorant, perfume, bulking agent, defoaming agent, release agent and ultraviolet absorber. In addition, PVA other than the PVA resin mentioned above, starch, and water-soluble polymers such as carboxymethylcellulose, methylcellulose and hydoxymethylcellulose may be blended.

The film-forming solution is prepared by dissolving a composition containing the PVA resin, the plasticizer, the surfactant, and optional inorganic filler or other components in a solvent such as water, dimethylsulfoxide, dimethylformamide, dimethylacetamide, methanol, n-propanol, isopropanol, and phenol. A uniform film-forming solution can be obtained either by dissolving the components in the solvent after blending all in advance or by respectively dissolving in the solvent and then mig the solutions respectively obtained. The film-forming solution thus prepared is made into the water-soluble PVA film by a common film-forming method such as cast film-forming method, wet film-forming method, dry film-forming method, extrusion film-forming method, and melt film-forming method.

The water-soluble PVA film is produced preferably by the cast film-forming method. The temperature of the metal surface to which the film-forming solution is cast is preferably from 80 to 230° C. If less than 80° C., the dried cast film is not completely peeled off from the metal surface and the blocking of resultant films tends to occur. If higher than 230° C., the film-forming solution foams to unfavorably give a porous film.

The water-soluble support and the water-soluble film are laminated by a bonding via a binder, a fuse bonding by heating, a bonding by pressure, etc., although not limited thereto. The binder is preferred to be water-soluble so as to prevent the binder from remaining as solid matter after removing the masking sheet by dissolution. Since the bonding via the binder is less productive and less cost-efficient in some cases as compared with the other bonding methods, the lamination is preferably performed by the heat-fuse bonding (heat press bonding) such as an emboss bonding using a heat roll and a calender bonding, or by a press bonding after spraying water onto the surface of the nonwoven fabric or film.

The temperature for the heat press bonding is not critical and preferably from 100 to 230° C. If less than 100° C., the bonding between the water-soluble film and the water-soluble support is insufficient to possibly cause the peeling off between the water-soluble film and the water-soluble support during the transportation and embroidery work to spoil the appearance of embroidered patterns or fail to exhibit the masking function. If higher than 230° C., the water-soluble support and the water-soluble film tend to crystallize to reduce their water solubility, to make the removal of the masking sheet by dissolution difficult. The pressure (line pressure) for the heat press bonding is preferably from 10 to 100 kgf/cm, and the processing speed is preferably from 5 to 50 m/min.

In the bonding after spraying water, the kind and temperature of water are not critical. For example, after lowering the surface melting points of the water-soluble support and the water-soluble film by spraying water, the heat press bonding is preformed using a heating roll of low temperature (60 to 200° C.). Alternatively, after partly dissolving the surfaces of the water-soluble support and the water-soluble film by spraying water of a temperature higher than their dissolution temperatures in water, the water-soluble support and the water-soluble film are press-bonded without heating.

The water-soluble support is preferably regular in its formation and uniform in its mass per unit area. The mass per unit area is preferably from 10 to 300 g/m² and more preferably from 20 to 100 g/m². Since the water-soluble film is used to prevent the sublimable dye from passing through the interstices between fibers, its mass per unit area and thickness are not particularly limited as far as the film is not easily broken during the embroidery work. The mass per unit area thereof is preferably from 10 to 200 g/m² and more preferably from 20 to 100 g/m². To prevent the rupture during the embroidery work, the strength of the water-soluble film is preferably from 1.0 to 50 N/cm.

### EXAMPLE

The present invention will be described in more detail by reference to the following examples. However, it should be noted that the scope of the present invention is not limited thereto. In the following examples, the measurements of properties and the transfer dyeing were conducted by the following methods.

(1) Mass Per Unit Area of Nonwoven Fabric (g/m²)

The weights of 12 pieces of 5 cm×17 cm nonwoven fabrics were measured, respectively. The average weight was divided by the surface area of the nonwoven fabric to calculate the mass per unit area.

(2) Mass Per Unit Area of Paper (g/m²)

Measured according to JIS P8124 “Paper and board-Determination of grammage.”

### (3) Dissolving Temperature in Water (° C.)

A water-soluble film was laminated to a nonwoven fabric or paper made of water-soluble fibers, to prepare a masking sheet. Into 400 ml of water, three pieces of masking sheets of 2 cm square were immersed. The temperature was raised at a rate of 3° C./min under stirring at 280 rpm. The temperature at which the masking sheet completely dissolved was employed as the dissolving temperature in water.

### (4) Transfer Dyeing

A felt cloth (“Sunfelt GR” manufactured by Sunfelt Co., Ltd.) or a commercially available cotton broad cloth was used as the embroidery base fabric. On the superposed masking sheet and embroidery base fabric each being 10 cm square, embroidered patterns were formed. Then, the embroidered patterns were dyed by a heat transfer at 200° C. for 20 s using a transfer paper which was made using a disperse dye according to the specification by Yamakami Sewing Thread Co., Ltd.

(5) Tenacity of Water-soluble Fiber (cN/dtex)

Measured according to JIS L1015 “Test methods for man-made staple fibres.”

### (6) Strength of Water-soluble Film (N/cm)

Measure according to JIS P8113 “Paper and board-Determination of tensile properties.”

### Example 1

PVA (polymerization degree: 1750; saponification degree: 88 mol %) was made into a crimped PVA fiber having a single fiber fineness of 2.2 dtex and a tenacity of 5.0 cN/dtex. Using 100 parts by mass of the PVA fiber as the water-soluble fiber, a random web (nonwoven fabric) having a mass per unit of 60.8 g/m² was produced. Separately, a PVA film having a strength of 8 N/cm and a mass per unit of 25 g/m² was produced from PVA having a polymerization degree of 1750 and a saponification degree of 88 mol %. The PVA film was overlaid on the nonwoven fabric and heat-fuse bonded by passing between a heated emboss roll and steel roll, to produce a masking sheet. The embossing was performed under the conditions of a bonding area ratio of 12%, an embossing temperature of 160° C., a line pressure of 40 kgf/cm, and a processing speed of 10 m/min.

The masking sheet was overlaid to cover the embroidery base fabric and embroidered patterns were produced thereon. The embroidered patterns were dyed using a transfer paper. The running and migration of dye into the non-embroidered areas were not found during the transfer dyeing. Thereafter, the masking sheet was completely removed by dissolution in warm water of 40° C. During the removal by dissolution, the dye was not desorbed from the masking sheet to cause no migration to the embroidered fabric. Thus, the masking sheet showed a good masking effect. The obtained embroidered fabric has a good and soft touch, and the embroidered patterns had a dear color and distinct profile.

### Example 2

PVA (polymerization degree: 1750; saponification degree: 96 mol %) was made into a crimped PVA fiber having a single fiber fineness of 1.7 dtex and a tenacity of 5.5 cN/dtex. Using 100 parts by mass of the PVA fiber as the water-soluble fiber, a random web (nonwoven fabric) having a mass per unit of 49.6 g/m² was produced. Separately, a PVA film having a strength of 8 N/cm and a mass per unit of 25 g/m² was produced from PVA having a polymerization degree of 1750 and a saponification degree of 96 mol %. The PVA film was overlaid on the nonwoven fabric and heat-fuse bonded by passing between a heated emboss roll and steel roll, to produce a masking sheet. The embossing was performed under the conditions of a bonding area ratio of 12%, an embossing temperature of 180° C., a line pressure of 40 kgf/cm, and a processing speed of 10 m/min.

The masking sheet was overlaid to cover the embroidery base fabric and embroidered patterns were produced thereon. The embroidered patterns were dyed using a transfer paper. The running and migration of dye into the non-embroidered areas were not found during the transfer dyeing. Thereafter, the masking sheet was completely removed by dissolution in warm water of 75° C. During the removal by dissolution, the dye was not desorbed from the masking sheet to cause no migration to the embroidered fabric. Thus, the masking sheet showed a good masking effect. The obtained embroidered fabric has a good and soft touch, and the embroidered patterns had a dear color and distinct profile.

### example 3

A slurry was prepared by dispersing in water 90 parts by mass of PVA staple fibers (single fiber fineness of 1.7 dtex and fiber length of 3 mm) which were made of PVA having a polymerization degree of 1750 and a saponification degree of 96 mol %, and 10 parts by mass of binder fibers (vinylon binder) having a single fiber fineness of 1.1 dtex and a fiber length of 3 mm. The slurry was made into a two-layered green paper by a short-circular wire paper machine and then dried by a Yankee dryer, to obtain a two-layered paper having a mass per unit area of 41.6 g/m² and a dissolving temperature in water of 70° C. Separately, a PVA film having a strength of 8 N/cm and a mass per unit of 25 g/m² was produced from PVA having a polymerization degree of 1750 and a saponification degree of 96 mol %. The PVA film was overlaid on the water-soluble paper and heat-fuse bonded by passing between a heated emboss roll and steel roll, to produce a masking sheet. The embossing was performed under the conditions of a bonding area ratio of 12%, an embossing temperature of 180° C., a line pressure of 40 kgf/cm, and a processing speed of 10 m/min.

The masking sheet was overlaid to cover the embroidery base fabric and embroidered patterns were produced thereon. The embroidered patterns were dyed using a transfer paper. The migration of dye into the embroidery base fabric were not found during the transfer dyeing. Thereafter, the masking sheet was completely removed by dissolution in warm water of 75° C. During the removal by dissolution, the dye was not desorbed from the masking sheet to cause no migration to the embroidered fabric. Thus, the masking sheet showed a good masking effect. The obtained embroidered fabric has a good and soft touch, and the embroidered patterns had a clear color and distinct profile.

### Comparative Example 1

PVA (polymerization degree: 1750; saponification degree: 96 mol %) was made into a crimped PVA fiber having a single fiber fineness of 1.7 dtex and a tenacity of 5.5 cN/dtex. Using 100 parts by mass of the PVA fiber as the water-soluble fiber, a random web was produced. The random web was passed between a heated emboss roll and steel roll, to produce a nonwoven fabric having a mass per unit of 25.5 g/m² and a dissolving temperature in water of 70° C. The embossing was performed under the conditions of a bonding area ratio of 12%, an embossing temperature of 180° C., a line pressure of 40 kg/cm, and a processing speed of 10 m/min. After covering the embroidery base fabric only with the nonwoven fabric thus produced, embroidered patterns were formed thereon. The embroidered patterns were dyed using a transfer paper. During the transfer dyeing, the dye migrated into the non-embroidered areas, showing that a masking effect practically acceptable was not achieved only by using a nonwoven fabric.

### Comparative Example 2

After covering the embroidery base fabric only with a commercially available thin water-soluble PVA film, embroidered patterns were formed thereon. The embroidered patterns were dyed using a transfer paper. During the transfer dyeing, the dye migrated into the embroidery base fabric through the embroidery stitches to blur the profile of the embroidered patterns. After dyeing, the water-soluble film was completely removed by dissolving in a warm water of 80° C. The dye was not desorbed during the removal by dissolution, to cause no migration of dye into the embroidery base fabric. However, the embroidered patterns of the obtained embroidered fabric were blurred to extremely reduce the commercial value.

### Comparative Example 3

After covering the embroidery base fabric with a commercially available thick simili paper, embroidered patterns were formed thereon. The embroidered patterns were dyed using a transfer paper. During the transfer dyeing, the migration of dye into the embroidery base fabric through the embroidery stitches was not observed. After dyeing, a part of the simili paper was removed by a warm water, but a substantial part thereof was not removed to remain under the embroidered patterns. The obtained embroidered fabric was partly hard in touch, and a part of the broken fibers of the remaining paper came out of the embroidery stitches, to significantly reduce the commercial value.

### INDUSTRIAL APPLICABILITY

Since being made of a laminated composite sheet of the water-soluble support and the water-soluble film, the masking sheet of the invention dose not adhere to the heat source during the transfer dyeing to enhance the workability. Using the masking sheet, the migration of dye into the vicinity of embroidered patterns through the embroidery stitches is prevented in the transfer dyeing, to provide embroidered fabrics having embroidered patterns with dear color even when the colored patterns are intricate. Since the masking sheet is easily and completely removed by dissolution in water, embroidered fabrics with good touch and soft feel are obtained. The embroidered fabrics produced using the masking sheet of the invention are applicable to one-point appliqués for accessory goods such as cap and bag and clothes such as socks, T-shirts and underwares, and other wide uses.

1. A water-soluble masking sheet for preventing a dye from migrating into non-embroidered areas during piece-dyeing embroidered patterns by transfer dyeing, which comprises a laminated composite sheet of a water-soluble film and a support made of water-soluble fibers.

2. The masking sheet according to claim 1, wherein the water-soluble fibers are polyvinyl alcohol-based fibers.

3. The masking sheet according to claim 1, wherein the water-soluble film is a polyvinyl alcohol-based film.

4. The masking sheet according to claim 1, wherein the support has a mass per unit area of 10 g/m² or more.

5. A method of producing an embroidered fabric, which comprises the steps of
overlaying the masking sheet as defined in claim 1 on an embroidery base fabric via the support of the masking sheet;
producing embroidered patterns on the overlaid masking sheet and embroidery base fabric;
piece-dyeing the embroidered patterns by a heat transfer dyeing or a pressure transfer dyeing; and
removing the masking sheet by dissolution in water.

6. An embroidered fabric produced by the method as defined in claim 5.
